(19) United States
(12) Patent Application Publication
(10) Pub. No.: US 2014/0115901 A1
(43) Pub. Date: May 1, 2014

(54) HAIR CLIPPER APPARATUS WITH BLADE ASSEMBLY

(71) Applicant: CONAIR CORPORATION, Stamford, CT (US)

(72) Inventor: Yen Fu Liao, New Taipei City (TW)

(73) Assignee: CONAIR CORPORATION, Stamford, CT (US)

(21) Appl. No.: 13/662,142

(22) Filed: Oct. 26, 2012

(51) Int. Cl. B26B 19/06

(52) U.S. Cl. CPC B26B 19/06
USPC 30/208

(57) ABSTRACT

A hair clipper apparatus includes a housing and a blade assembly mountable to the housing. The blade assembly includes a first blade member having a plurality of first teeth with each said first tooth defining a first longitudinal axis of symmetry and a first primary cutting edge and a second blade member having a plurality of second teeth with each second tooth defining a second longitudinal axis of symmetry and a second primary cutting edge. Each second tooth may have a recessed segment adjacent the second primary cutting edge dimensioned to collect hair disposed between the first and second primary cutting edges. The first blade member and the second blade member are adapted for relative reciprocal movement to cut the hair collected within the recessed segment.

### BACKGROUND

1. Technical Field

The present invention relates to a hair clipper or trimmer, and, more particularly, relates to a blade assembly for a hair clipper having enhanced cutting capabilities.

2. Description of the Related Art

Electric hair clippers having a clipper blade assembly are known in the art. Most conventional hair clippers include a stationary blade and a reciprocating blade. The stationary blade and the reciprocating blade each have a plurality of teeth along leading edges of the blades. The clipper blade assembly may be mounted to the clipper handle such that the teeth of the stationary blade are substantially parallel to the teeth of the reciprocating blade. In this manner, oscillating the reciprocating blade with respect to the stationary blade trims hair positioned between the teeth. Examples of hair clippers are disclosed in commonly assigned U.S. Pat. No. 6,536,116 to Fung and U.S. Pat. No. 6,742,262 to Rizzuto et al., the entire contents of each disclosure being hereby incorporated by reference herein.

### SUMMARY

The present invention is directed further improvements in hair clipper or trimmer devices. In accordance with one embodiment, a hair clipper apparatus includes a housing and a blade assembly mountable to the housing. The blade assembly includes a first blade member having a plurality of first teeth with each first tooth defining a first longitudinal axis of symmetry and a first primary cutting edge, and a second blade member having a plurality of second teeth with each second tooth defining a second longitudinal axis of symmetry and a second primary cutting edge. Each second tooth may have a recessed segment adjacent the second primary cutting edge dimensioned to collect hair disposed between the first and second primary cutting edges. The first blade member and the second blade member are adapted for relative reciprocal movement to cut the hair collected within the recessed segment.

Each second tooth of the second blade member may include at least two second primary cutting edges extending along the longitudinal axis and being separated by the recessed segment. In embodiments, each second tooth of the second blade member may include at least three second primary cutting edges extending along the longitudinal axis with longitudinally adjacent second primary cutting edges being separated by a recessed segment. In other embodiments, each second tooth of the second blade member may include at least two pairs of the second primary cutting edges which may be symmetrically arranged in diametrical opposed relation about the second longitudinal axis. Each first tooth of the first blade member may include a pair of first primary cutting edges symmetrically arranged in diametrical opposed relation about the first longitudinal axis. The first primary cutting edge may be dimensioned to extend at a first primary angle with respect to the first longitudinal axis and the second primary cutting edges may be dimensioned to extend at a second primary angle with respect to the second longitudinal axis different than the first primary angle. The first primary angle may be greater than the second primary angle. The first primary angle may range from about 10 degrees to about 20 degrees while the secondary primary angle may range from about 5 degrees to about 15 degrees. In embodiments, the first blade member may be a movable blade member and the second blade member may be stationary.

In another embodiment, a hair clipper apparatus includes a housing and a blade assembly mountable to the housing. The blade assembly includes a first blade member having a plurality of first teeth with each first tooth defining a first longitudinal axis of symmetry and having a pair of first primary cutting edges symmetrically arranged about the first longitudinal axis, and a second blade member having a plurality of second teeth with each second tooth defining a second longitudinal axis of symmetry and having at least two pairs of second primary cutting edges symmetrically arranged about the second longitudinal axis. Longitudinally adjacent pairs of the at least two pairs of second primary cutting edges are longitudinally spaced and defining a recessed collecting zone therebetween dimensioned to gather hair. At least one of the first and second blade members are adapted for reciprocal movement relative to the other to cut hair between the first and second teeth and within the collecting zone.

### BRIEF DESCRIPTION OF THE DRAWINGS

Various embodiments of the present disclosure are described hereinbelow with references to the drawings, wherein:

FIG. 1 is a perspective view of a hair clipper or trimmer incorporating the blade assembly of the present invention;

FIG. 2 is a front plan view of the apparatus with portions of the housing removed illustrating the internal components of the housing and the blade assembly in accordance with the principles of the present disclosure;

FIG. 3 is an enlarged view of the area of detail designated in FIG. 2 illustrating the reciprocating blade member and the stationary blade member of the blade assembly;

FIGS. 4-5 are front and rear plan views respectively of the reciprocating blade member of the blade assembly;

FIGS. 6-7 are enlarged views of the areas of detail designated in FIGS. 4-5, respectively, illustrating the geometry of the teeth of the reciprocating blade member;

FIGS. 8-9 are front and rear plan views respectively of the stationary blade member of the blade assembly;

FIGS. 10-11 are enlarged views of the areas of detail designated in FIGS. 8-9, respectively, illustrating the geometry of the teeth of the stationary blade member; and

FIGS. 12-14 are views illustrating alternate vertical positions of the movable blade member relative to the stationary blade member.

### DETAILED DESCRIPTION OF THE EMBODIMENTS

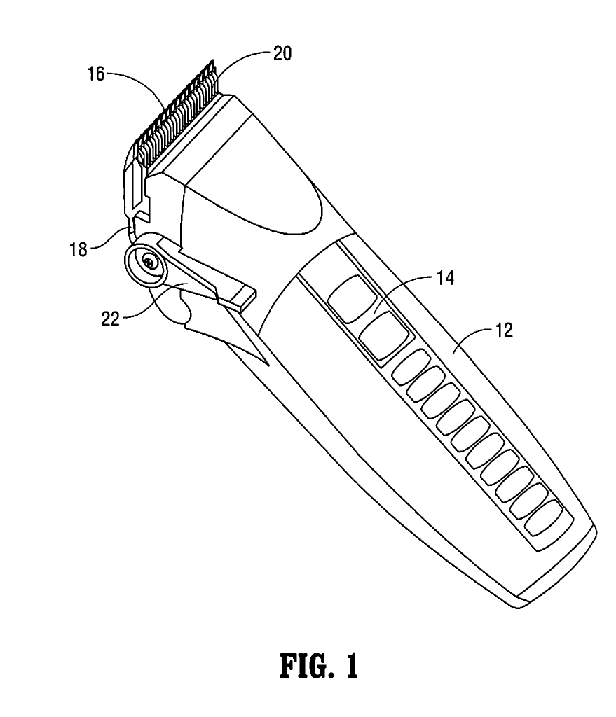

Referring to the drawings and, in particular, FIG. 1, there is shown a hair clipper in accordance with a preferred embodiment of the present invention generally represented by reference numeral 10. Clipper 10 has housing 12, and a motor and driver (not shown) located in the housing 12. The motor and driver can be any conventional driver mechanism for use in a hair clipper. Housing 12 has user operating switch 14 for turning the motor “on” and “off”. A blade assembly 16 is mounted to the forward end of housing 12. Blade assembly 16 has stationary blade 18 and reciprocating blade 20. Reciprocating blade 20 is adapted to reciprocate relative to stationary comb blade 18 to cut hair received between the blades 18, 20. A control lever 22 is provided to adjust the distance between comb blade 18 and cutter blade 20 and, thus, adjust the length or depth of cut. Further details of hair clipper 10 may be ascertained by reference to the Rizzuto '262 patent.

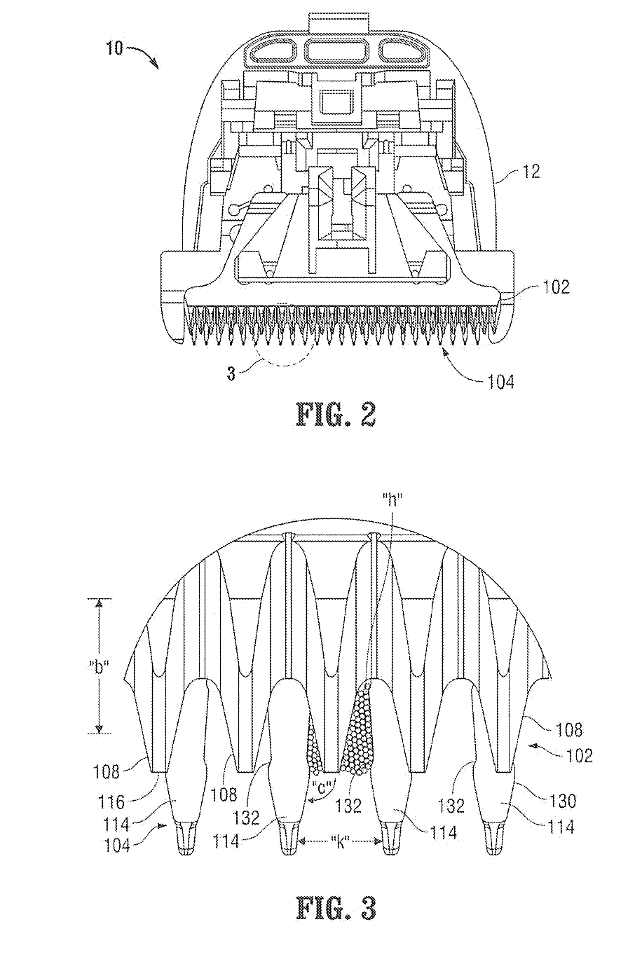

Referring now to FIGS. 2-3, there is illustrated the blade assembly 100 in accordance with the principles of the present disclosure, and incorporable into the hair clipper 10. Blade assembly 100 may be mounted to housing 12 through conventional means. In one embodiment, blade assembly 100 includes first blade member 102 and second blade member 104. First blade member 102 may be a reciprocating blade movable in the direction of directional arrows “k” as is known in the art. Second blade member may be secured relative to housing 12, and, is thus a stationary blade member 104. In the alternative, first blade member 102 may be stationary while second blade member 104 reciprocates. As a further alternative, first and second blade members 102, 104 may both reciprocate. First blade member 102 may be adjusted via control lever 22 to control the positioning of first blade member 102 relative to second blade member 104 in the direction of directional arrows “b” (FIG. 3) to control the depth of cut. It is envisioned that first blade member 102 may be selectively positioned at a plurality of vertical positions relative to second blade member 104.

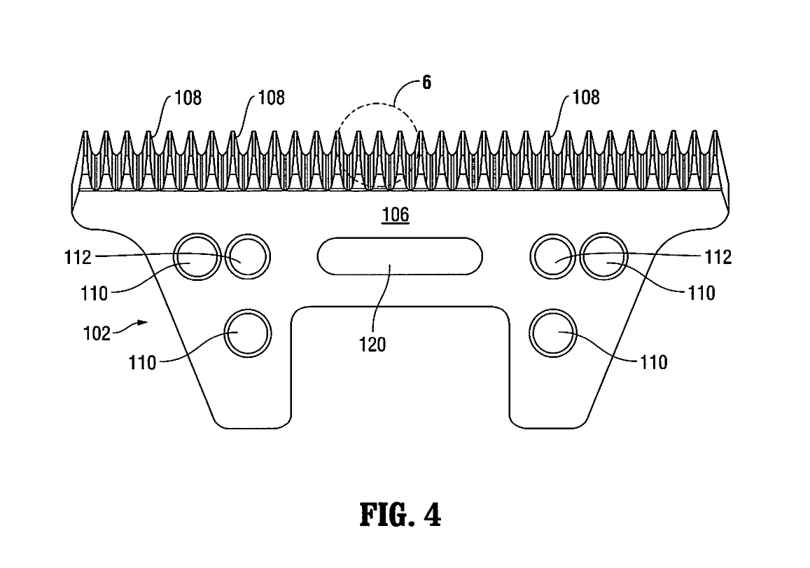

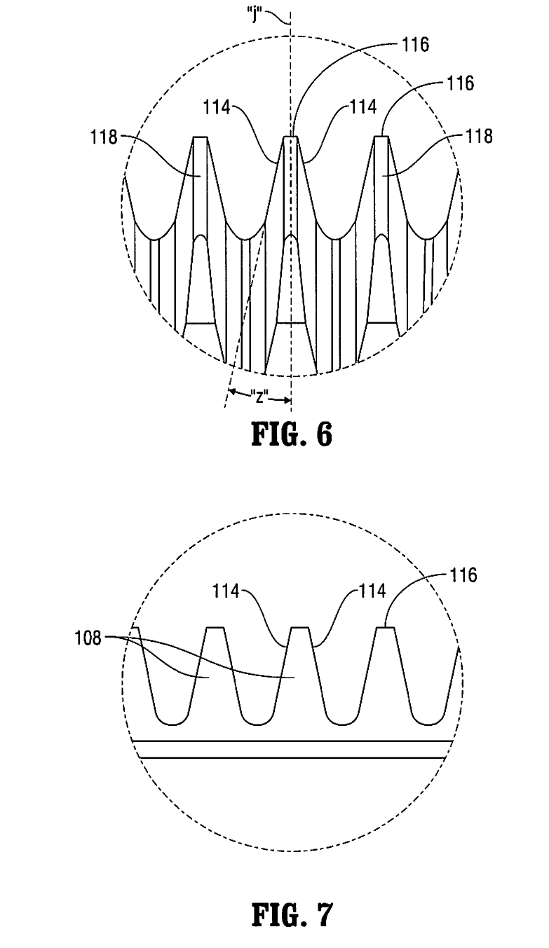

Referring now to FIGS. 4-7, in conjunction with FIG. 3, first blade member 102 will be discussed. First blade member 102 includes first base 106 and a plurality of first teeth 108 depending outwardly from the first base 106. First base 106 includes means, i.e., in the form of apertures or slots 110, 112 for securing the first movable blade member 102 to housing 12. Each first tooth 108 defines first longitudinal axis of symmetry “j” (FIG. 6). Each first tooth 108 includes a pair of diametrically opposed primary cutting edges 114 extending along the longitudinal axis “j” towards first base 106. First primary cutting edges 114 define an angle “t” ranging from about 10° to about 20°, possibly about 15°, relative to the longitudinal axis “j”. First primary cutting edges 114 may be generally sharp to cut hair. Each of first teeth 108 may include a planar or flat outermost edge or surface 116, which may or may not be sharpened. Outer edge 116 facilitates the cutting action on the hair engaged by the blade assembly 100. The front of each tooth 108 may include a raised segment 118 (FIG. 6) while the rear of each tooth 108 may be substantially planar (FIG. 7).

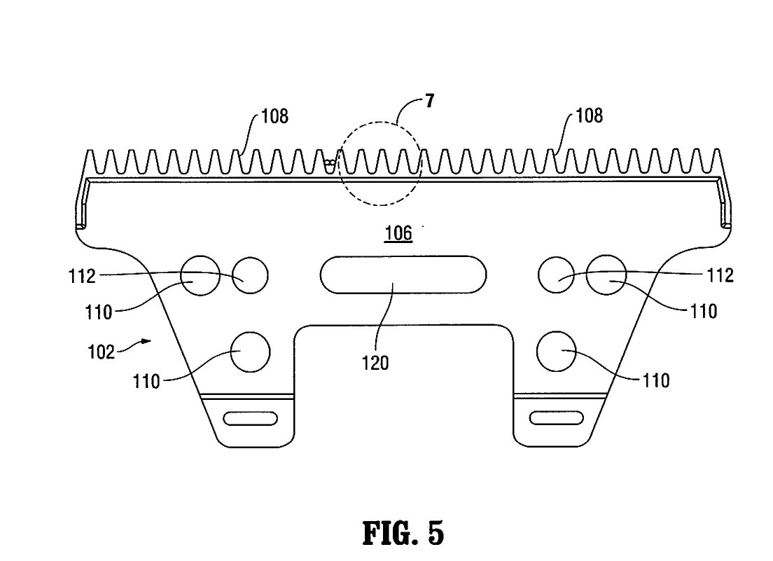

First blade member 102 is adapted to reciprocate in the direction of directional arrows “k”. (FIG. 3) In general, a reciprocating drive (not shown) in operative engagement with the motor of housing 12 is received within elongated drive slot 120 (FIGS. 4 and 5) of first blade member 102 to effect the reciprocating action.

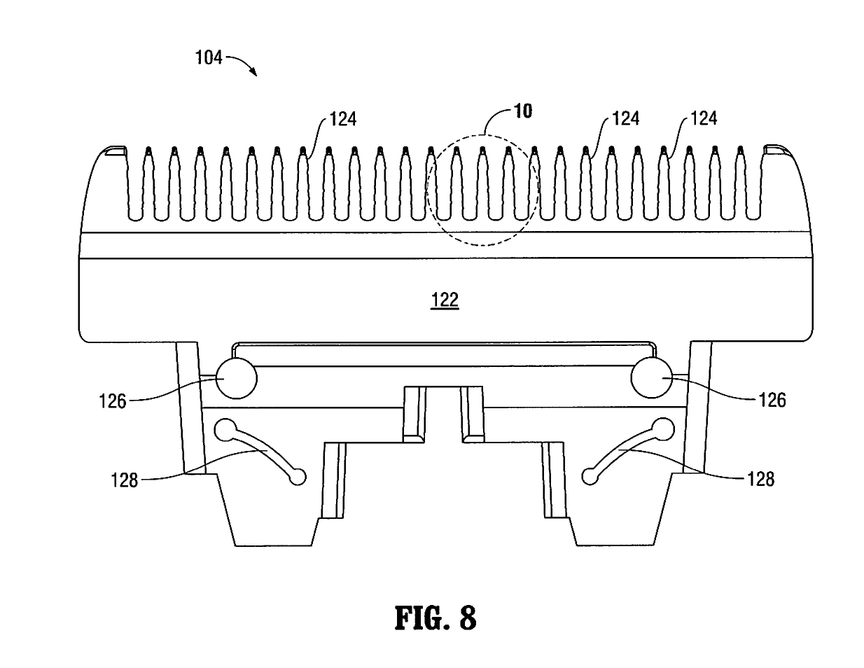

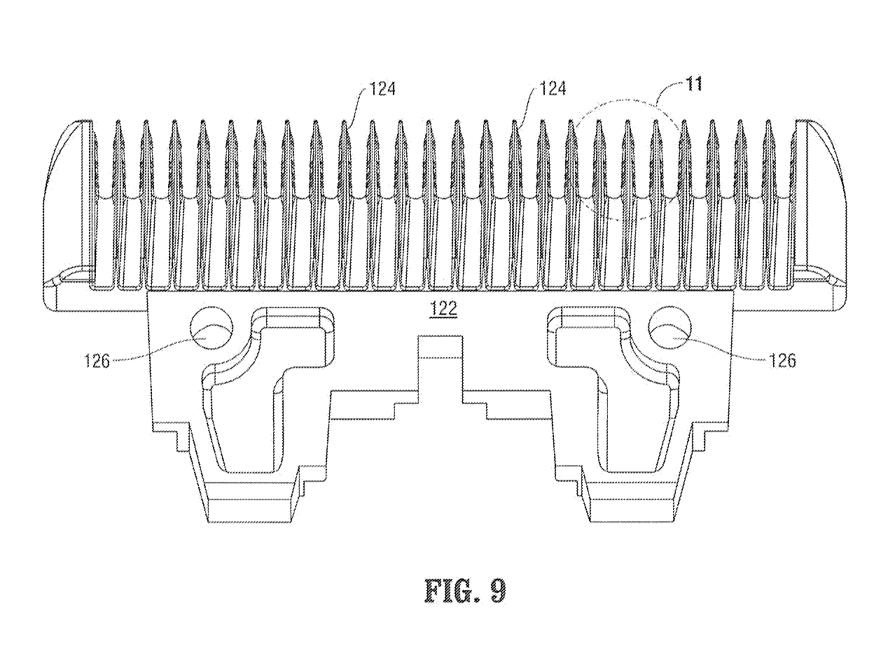

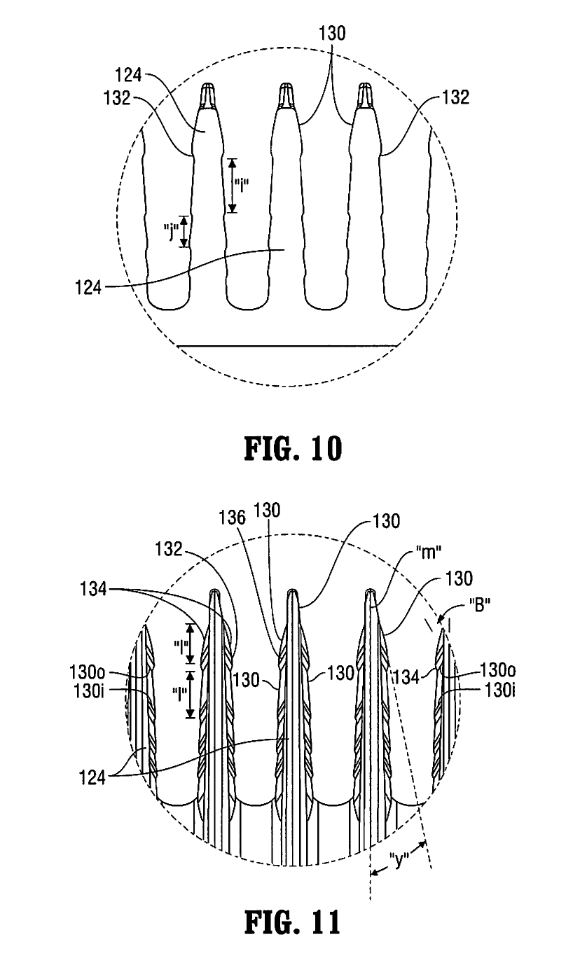

Referring now to FIGS. 8-11, in conjunction with FIG. 3, second or stationary blade member 104 will be discussed. Second blade member 104 includes second base 122 and a plurality of second teeth 124 depending outwardly from the second base 122. Second base 122 includes means, i.e., in the form of apertures or slots 126, 128 for securing the second blade member 104 to housing 12. Each second tooth 124 defines a longitudinal axis of symmetry “m” (FIG. 11).

Each second tooth 124 includes at least one or more second primary cutting edges 130 disposed along the longitudinal axis “m” of each tooth 124 with adjacent second primary cutting edges 130 being in longitudinal spaced, staggered or unlated relation. Symmetrical pairs of second primary cutting edges 130 may be disposed in diametrical relation along the longitudinal axis “m”. The respective lengths “l” of each second primary cutting edge 130 of the pairs may be different or in the alternative be substantially the same. In embodiments, the respective lengths “l” are different. Second primary cutting edges 130 define an angle “y” ranging from about 5° to about 15°, possibly about 10°, relative to second longitudinal axis “m” of symmetry. In embodiments, the respective angles “y” of the pairs of second primary edges 130 may be the same. In one embodiment, the angles “y” of each pair is not equal and differs from the outermost edge 124e of the second tooth 124 toward the second base 122 or valley region of the second tooth 124. In embodiments, the angle “y” may increase from the outermost edge 124e toward base 122 or optionally may decrease. The angle or pitch “y” may vary to fit the height or taper control of the first movable blade member 102 as controlled by the control lever 22 as discussed hereinabove.

As indicated hereinabove, longitudinally adjacent second primary cutting edges 130 (including longitudinally adjacent pairs of the second primary cutting edges 130) are spaced from each other to define a recess or gap 132 for receiving hair particles. (see FIGS. 3, 10 and 11) The spacing may be effected through the angle of inclination “t” of the second primary cutting edges 130 with the outermost end 130o of each second primary cutting edge 130 being disposed radially inward relative to the longitudinal axis “m” of each tooth 124 compared to the inner most end 130i of each second primary cutting edge 130. Extending between each longitudinally adjacent second primary cutting edge 130 towards second base 120 may be surface or supplemental edge 134. Supplemental edge 134 defines an angle “b” ranging from about 30° to about 60°, possibly about 45°. (FIG. 11) The angle “b” is preferably a negative angle relative angle “y”, i.e., arranged at an opposite angular direction than angle “y”. This reverse angular arrangement of supplemental edge 134, in combination with the inclination of each adjacent second primary cutting edges 130, defines the contour or recess 132 for collecting hair during the cutting process. Supplemental edge 134 may be sharp to facilitate the cutting process. Each second tooth 124 may optionally include a third or intermediate edge 136 between the second primary cutting edge 130 and the supplemental edge 134. Intermediate edge 136 also may be sharp to facilitate the cutting process.

The front of each of the teeth 108 of the stationary blade member may be substantially planar while the rear has some depth or raised segments 138, 140 adjacent second primary cutting edge 130, intermediate edge 136 and supplemental edge 134. The depth of these segments facilitate grouping of hair during the cutting process.

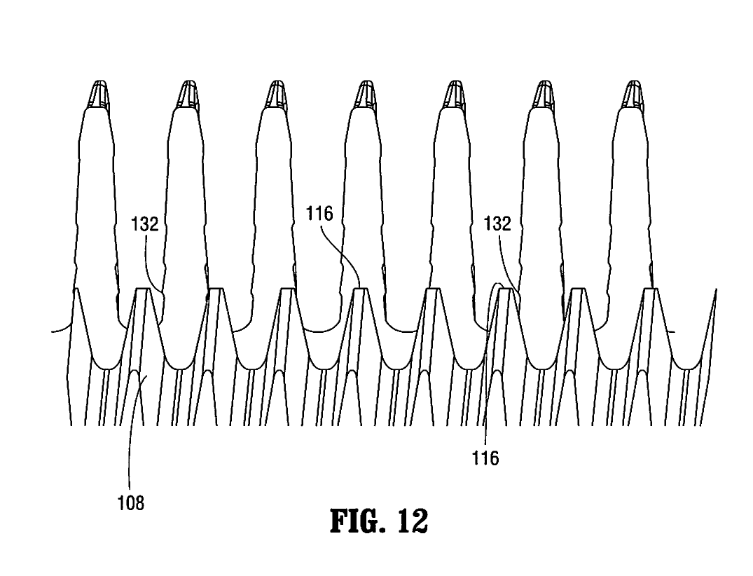

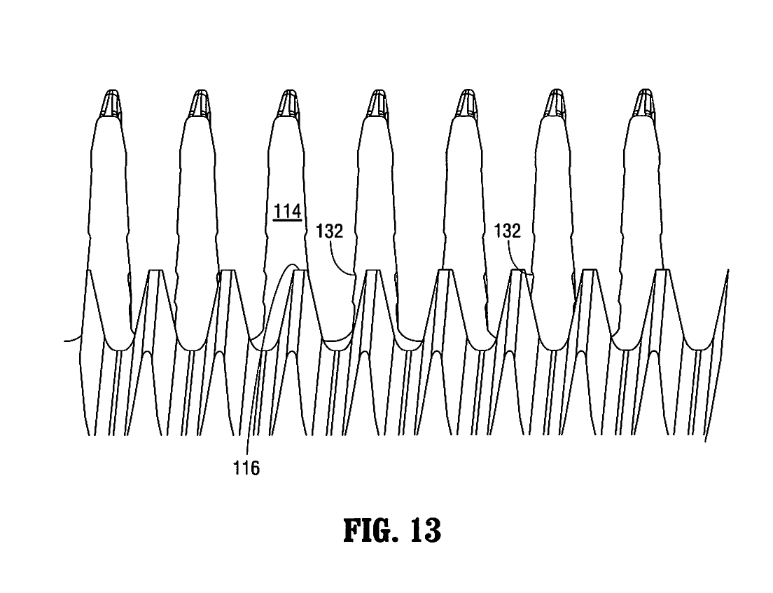

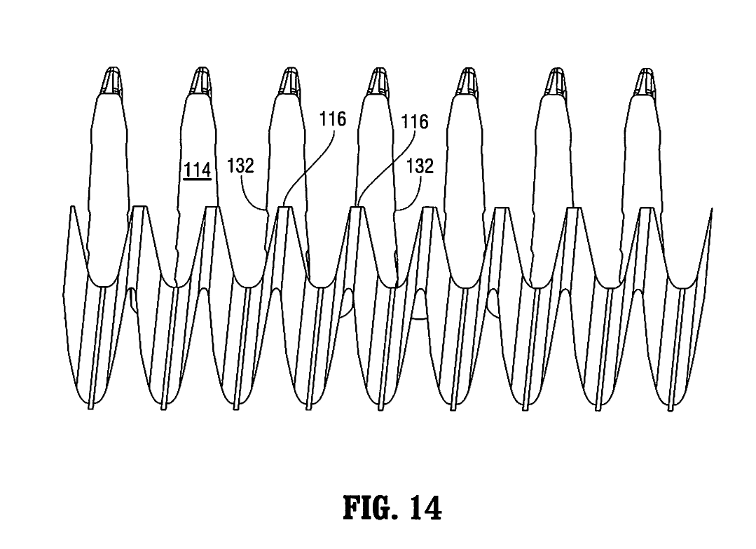

Referring back to FIG. 3, during use, the blade assembly 100 is positioned to engage the hair. During activation, the hair follicles “h” are collected or gathered between the first primary cutting edges 114 of the first teeth 108 and the secondary primary cutting edges 130 of the second teeth 124 and within the recess or contour 132 defined between longitudinally adjacent second primary cutting edges 130. The first primary cutting edges 114 of the first teeth 108 of the first blade member 102 passes through the collected hair follicles “h” to effect a sickle or circular cut on the hair during the trimming process. For example, the first primary cutting edges 114 and also possibly the planar edges 116 of the first blade member 102 may contact the hair follicles “h” and, due to the respective geometries of each tooth including the gaps 132 as provided by the intersection of the second primary cutting edges 130 and the supplemental edges 134 exert a cutting or severing force in the direction of directional arrow “a” (FIG. 3), which may have an arcuate or circular component of direction “c”, potentially enhancing the cutting action of the blade assembly 100. In addition, during use, the outermost edge 116 of the first movable blade member 102 extends a bit higher or beyond the recess or contours 132 of the second stationary blade member 104 as shown in FIG. 3 thus trapping the hair follicles “h” within the contours or undercuts 132 such that the follicles “h” are prevented from slipping out and are cut by the respective edge 114 of the first blade member 102. As also noted above, the vertical position of first blade member 102 relative to second blade member 104 may be controlled via control lever 22 to vary the length of cut of the hair. It is envisioned that in each of the vertical positions of first blade member 102, the outermost edge 116 of the first movable blade member 102 would extend slightly beyond the respective contour or undercut 132 along the length of each second tooth 124 whereby the hair follicles “h” would be retained or trapped within the respective contours or undercuts 132 in the manner discussed. FIGS. 12-14 illustrate alternate vertical positions of movable blade member 102 relative to stationary blade member 104 and the respective positions of outermost edge beyond contours 132.

Although the illustrative embodiments of the present disclosure have been described herein with reference to the accompanying drawings, the above description, disclosure, and figures should not be construed as limiting, but merely as exemplifications of particular embodiments. It is to be understood, therefore, that the disclosure is not limited to the precise embodiments described herein, and that various other changes and modifications may be effected by one skilled in the art without departing from the scope or spirit of the present disclosure.

What is claimed is:

1. A hair clipper apparatus, which comprises:
a housing; and
a blade assembly mountable to said housing, said blade assembly including:
a first blade member including a plurality of first teeth, each said first tooth defining a first longitudinal axis of symmetry and having a first primary cutting edge;
a second blade member including a plurality of second teeth, each said second tooth defining a second longitudinal axis of symmetry and having a second primary cutting edge, each said second tooth having a recessed segment adjacent the second primary cutting edge dimensioned to collect hair disposed between said first and second primary cutting edges; and
said first blade member and said second blade member adapted for relative reciprocal movement.

2. The hair clipper apparatus according to claim 1 wherein each said second tooth of said second blade member includes at least two second primary cutting edges extending along the longitudinal axis and being separated by the recessed segment.

3. The hair clipper apparatus according to claim 2 wherein each said second tooth of said second blade member includes at least three second primary cutting edges extending along the longitudinal axis, longitudinally adjacent second primary cutting edges being separated by a recessed segment.

4. The hair clipper apparatus according to claim 2 wherein each said second tooth of said second blade member includes at least two pairs of said second primary cutting edges, said second primary cutting edges of each said at least two pairs symmetrically arranged in diametrical opposed relation about said second longitudinal axis.

5. The hair clipper apparatus according to claim 4 wherein each said first tooth of said first blade member includes a pair of first primary cutting edges symmetrically arranged in diametrical opposed relation about said first longitudinal axis.

6. The hair clipper apparatus according to claim 5 wherein said first primary cutting edges are dimensioned to extend at a first primary angle with respect to said first longitudinal axis and said second primary cutting edges are dimensioned to extend at a second primary angle with respect to said second longitudinal axis different than said first primary angle.

7. The hair clipper apparatus according to claim 6 wherein said first blade member is a movable blade member and said second blade member is stationary.

8. The hair clipper apparatus according to claim 7 wherein said first primary angle is greater than said second primary angle.

9. The hair clipper apparatus according to claim 8 wherein said first primary angle ranges from about 10 degrees to about 20 degrees.

10. The hair clipper apparatus according to claim 9 said secondary primary angle ranges from about 5 degrees to about 15 degrees.

11. A hair clipper apparatus, which comprises:
a housing; and
a blade assembly mountable to said housing, said blade assembly including:
a first blade member including a plurality of first teeth, each said first tooth defining a first longitudinal axis of symmetry and having a pair of first primary cutting edges symmetrically arranged about said first longitudinal axis;
a second blade member including a plurality of second teeth, each said second tooth defining a second longitudinal axis of symmetry and having at least two pairs of second primary cutting edges symmetrically arranged about said second longitudinal axis, longitudinally adjacent pairs of said at least two pairs of second primary cutting edges being longitudinally spaced and defining a recessed collecting zone therebetween dimensioned to gather hair; and
at least one of said first and second blade members adapted for reciprocal movement relative to the other of said first and second blade members to cut hair between said first and second teeth.
